(19) United States
(12) Patent Application Publication
(10) Pub. No.: US 2009/0147947 A1
(43) Pub. Date: Jun. 11, 2009

(54) DIGITAL-ENCRYPTION HARDWARE ACCELERATOR

(75) Inventors: Arni Ingimundarson, Freising (DE); Adolf Baumann, Haag a.d. Amper (DE)

Correspondence Address: TEXAS INSTRUMENTS INCORPORATED, P O BOX 655474, M/S 3999, DALLAS, TX, 75265, US

(73) Assignee: Texas Instruments Deutschland GmbH, Freising (DE)

(21) Appl. No.: 12/264,782

(22) Filed: Nov. 4, 2008

(30) Foreign Application Priority Data
Nov. 5, 2007 (DE) 10 2007 052 656.5

(51) Int. Cl. H04L 9/06

(52) U.S. Cl. 380/29; 380/277

(57) ABSTRACT

An electronic device for encrypting and decrypting data blocks of a message having n data blocks in accordance with the data encryption standard (DES) is provided. The electronic device has a first data processing channel having a first processing stage for performing encryption and decryption of data blocks of a predefined length, and a first input data buffer coupled to a data input and to the first processing stage, and a second data processing channel having a second processing stage for performing encryption and decryption of data blocks, a second data input buffer coupled to an output of the first processing stage and to the second processing stage. The electronic device also has a control stage (FSM) for controlling the first processing stage and the second processing stage, so as to perform an encryption or decryption step with the second processing stage on an encrypted/decrypted data block output from the first processing stage. The control stage is adapted to control the first processing stage to perform data encryption or decryption according to the data encryption standard on each block and to control the second processing stage to compute a message authentication code over the encrypted or decrypted message received from the first processing stage block-by-block.

### FIELD OF THE INVENTION

The present invention relates to an electronic device for encrypting and decrypting data, more specifically, the present invention relates to an electronic device for performing symmetrical cryptographical operations on 8 byte-size data blocks according to the Digital-Encryption Standard (DES).

### BACKGROUND OF THE INVENTION

The ISO/IEC 7816-4 Secure Messaging Protocol requires a double-length key triple-DES data encryption and a double-length key triple-DES based message authentication code (MAC). The conventional implementation of this protocol requires the encrypted message to be calculated first and then the computation of the message authentication code on the encrypted message data to be calculated afterwards. The two-step encryption and decryption is conventionally sequentially implemented. This requires a substantial amount of time as the data blocks are first encrypted or decrypted and the message authentication code is subsequently encrypted or decrypted over the whole message length. Further, extra processing time is required for a key exchange, since encryption and MAC are using different keys. Furthermore, extra storage capacities and data paths for handling the encrypted or decrypted data and calculating interim results is required.

### SUMMARY OF THE INVENTION

It is a general object of the present invention to provide an electronic device adapted to perform the necessary decryption and encryption steps in accordance with the DES standard, which is more efficient and less complex than the conventional solution.

According to an aspect of the present invention, an electronic device is provided for encrypting and decrypting data blocks of a message having n data blocks in accordance with the data encryption standard (DES as defined in the ISO/IEC 7816-4 Secure Messaging Protocol). The electronic device comprises a first data processing channel, which includes a first processing stage for performing encryption and decryption of data blocks of a predefined length. Further, there is a first input data buffer coupled to a data input and to the first processing stage. In a second data processing channel, there is a second processing stage for performing encryption and decryption of data blocks in accordance with the DES standard. Further, there is a second data input buffer coupled to an output of the first processing stage and to the second processing stage. The electronic device further comprises a control stage for controlling the first processing stage and the second processing stage, in a manner so as to perform an encryption or decryption step with the second processing stage on an encrypted or decrypted data block output from the first processing stage. The control stage is adapted to control the first processing stage to perform data encryption or decryption according to the data encryption standard on each block and to control the second processing stage to compute a message authentication code over the encrypted or decrypted message received from the first processing stage block-by-block.

Accordingly, the aspect of the present invention provides a solution, which is based on pipelined and parallel architecture using two processing stages. The processing stage is typically a processor unit dedicated to perform encryption or decryption in accordance with the DES standard. Therefore, the processing stage is also referred to as crypto core. The processing stages or crypto cores allow the execution of two DES operations in parallel. Each crypto core is capable of performing symmetrical cryptographical operations on 8 byte size data blocks according to the DES Standard. Each core can handle single- and triple-DES operations. A single-DES operation encrypts or decrypts a 64 bit wide data block using a 64 bit (i.e. 56 bit plus 8 parity bits in accordance with the DES Standard) key while a 128 bit key is used for triple-DES operations. A triple-DES operation consists of three successive rounds of single-DES operations. Before an encrypt or decrypt operation can be started, the crypto key must be loaded into the corresponding key register.

For triple-DES a single 128 bit key K is defined and has two 64 bit keys K_{A} and K_{B} concatenated together:

K:=K_{A}∥K_{B}

A triple-DES encryption operation is defined as follows:

1) C′:=DES(K_{A}, P)

2) C″:=DES⁻¹(K_{B}, C′)

3) C:=DES(K_{A}, C″)

And a triple-DES decryption operation is defined as follows:

4) P′:=DES⁻¹(K_{A}, C)

5) P″:=DES(K_{B}, P′)

6) P:=DES⁻¹(K_{A}, P″)

where DES means a single-DES encryption, DES⁻¹ a single-DES decryption, P a plain text block and C a cipher text block.

After the desired mode for the channel has been configured, the data can be written to the input data buffer. When an 8 byte block of data has been written to the buffer, the DES operation can be started manually or, if so configured, it is started automatically when the last (8^{th}) byte of the block is written into the data buffer. An interrupt can be generated upon completion of the operation.

The control stage is adapted to control the first processing stage to perform data encryption according to the data encryption standard on each block and to control the second processing stage to compute a message authentication code over the encrypted message received from the first processing stage (DES crypto core) block-by-block. This is in accordance with the DES Standard and the two processing stages of the electronic device according to the present invention are specifically adapted and controlled to perform data encryption or decryption block-by-block, wherein the encrypted or decrypted blocks are further computed in the processing stage (DES crypto core), so as to retrieve or to apply the message authentication code over the whole message, i.e. all blocks of the message, but on a block-by-block basis.

According to an aspect of the present invention, the electronic device comprises a first key register for storing a first encryption or decryption key to be used by the first processing stage, and a second key register for storing a second encryption or decryption key to be used by the second processing stage. This aspect of the present invention allows the encryption or decryption operations to be performed by the two processing stages basically independently from each other. An exchange of keys in the registers is not necessary.

In order to implement a real pipelined, partially parallel architecture, the second input data buffer should advantageously have twice the size of the first data buffer. Having a data buffer of double size is particularly helpful for a pipelined operation, as consecutive results and header information for the second crypto core have to be stored in the second channel. In fact, the computation of the message authentication code in the second channel requires feeding alternately encrypted or decrypted data blocks output from the first channel to the second processing stage. Therefore, a double size input data buffer improves throughput and speed. The first processing stage and the second processing stage are both adapted to perform single-DES and triple-DES operations. The first and second encryption keys have a maximum length of 128 bit. Accordingly, the first and second key registers can be restricted to this maximum bit length. This allows the storage capacity to be limited.

According to an aspect of the present invention, the first channel is preferably adapted to perform ECB mode and CBC mode for encryption and decryption and the second channel is advantageously adapted to perform ECB for encryption and decryption and CBC mode for encryption only. When encrypting or decrypting multiple blocks of data, the blocks can either be operated independently of each other or the result of an operation can be used to influence the next one. In an encryption and decryption according to the Electronic Codebook mode (ECB), each block is encrypted and decrypted independently of the other blocks of a message. This basic encryption and decryption configuration is shown in FIG. 1. Pₙ is a block n in plain text. Cₙ refers to a cipher block. FIG. 2 shows encryption and decryption according to the cipher block chaining mode (CBC). On the left-hand side a cipher block chaining mode for encryption is illustrated. The plain input data block P₁ is first buffered and XORed with the results of the previous operation before it is encrypted. For the first operation an initial cipher vector C₀ is used. The left-hand side of FIG. 2 shows the corresponding decryption operation. During decryption the data output of the crypto core (3)DES⁻¹ must be XORed with the previous ciphered input block before the plain data can be read. For the first operation and the decryption the same initial vector C₀ must be used for the encryption. According to this aspect of the present invention, the channels of the electronic device are adapted to perform ECB mode and CBC mode. However, the second channel can be simplified in that only CBC mode is provided for encryption. This reduces complexity of the circuits. For the present invention, a data block preferably has a bit length of 64 bit.

An aspect of the present invention also relates to a method for encrypting a message having n data blocks. A data block is encrypted in a first processing stage in accordance with a single-DES or triple-DES operation. The encrypted data block is passed to a second processing stage (crypto core). In this second processing stage the encrypted data block is further encrypted in accordance with a single-DES or triple-DES operation. The first encryption step performs data encryption on each block and the second encryption step performs computation of a message authentication code over the encrypted message block in a block-by-block manner. Likewise, a method for decrypting a message having n encrypted data blocks and a message authentication code is provided. The encrypted data block is decrypted in a first processing stage in accordance with a single-DES or triple-DES operation. The decrypted data block is passed to a second processing stage, where the decrypted data block is further decrypted in accordance with a single-DES or triple-DES operation. The first decrypting step performs data decryption on each block and the second decrypting step retrieves the message authentication code over n blocks. In this way, it is possible to compute the whole encryption in a partially parallel manner using a pipelined structure, which incorporates two independent processing stages (crypto cores).

### BRIEF DESCRIPTION OF THE DRAWINGS

Further aspects of the present invention will ensue from the description hereinbelow of the preferred embodiments, with reference to the accompanying drawings, in which:

FIG. 1 shows a simplified block diagram illustrating ECB mode;

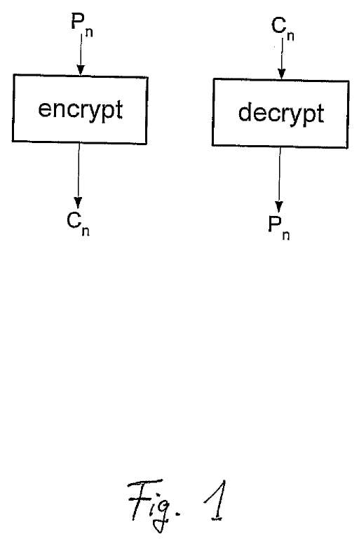

FIG. 2 is a simplified block diagram illustrating CBC mode;

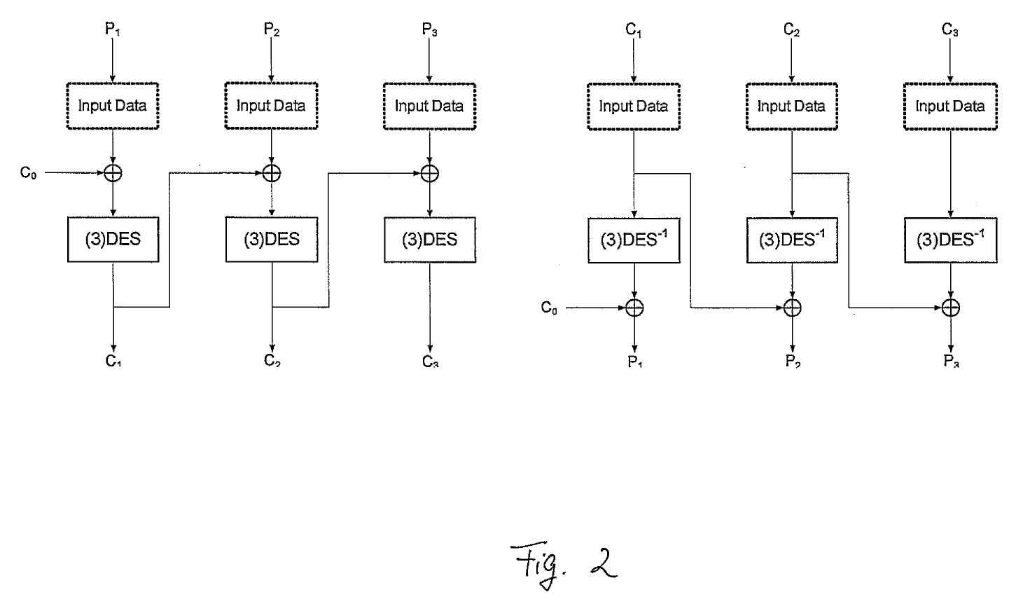

FIG. 3 is a simplified block diagram of an embodiment of the present invention;

FIG. 4 shows a diagram illustrating the general steps of data encryption according to the DES Standard;

FIG. 5 shows a diagram illustrating the decryption steps according to the DES Standard;

FIG. 6 is a flow chart illustrating the data flow in an electronic device according to the present invention for encryption; and

FIG. 7 is a flow chart illustrating the data flow in an electronic device according to the present invention for decryption.

### DETAILED DESCRIPTION OF THE INVENTION

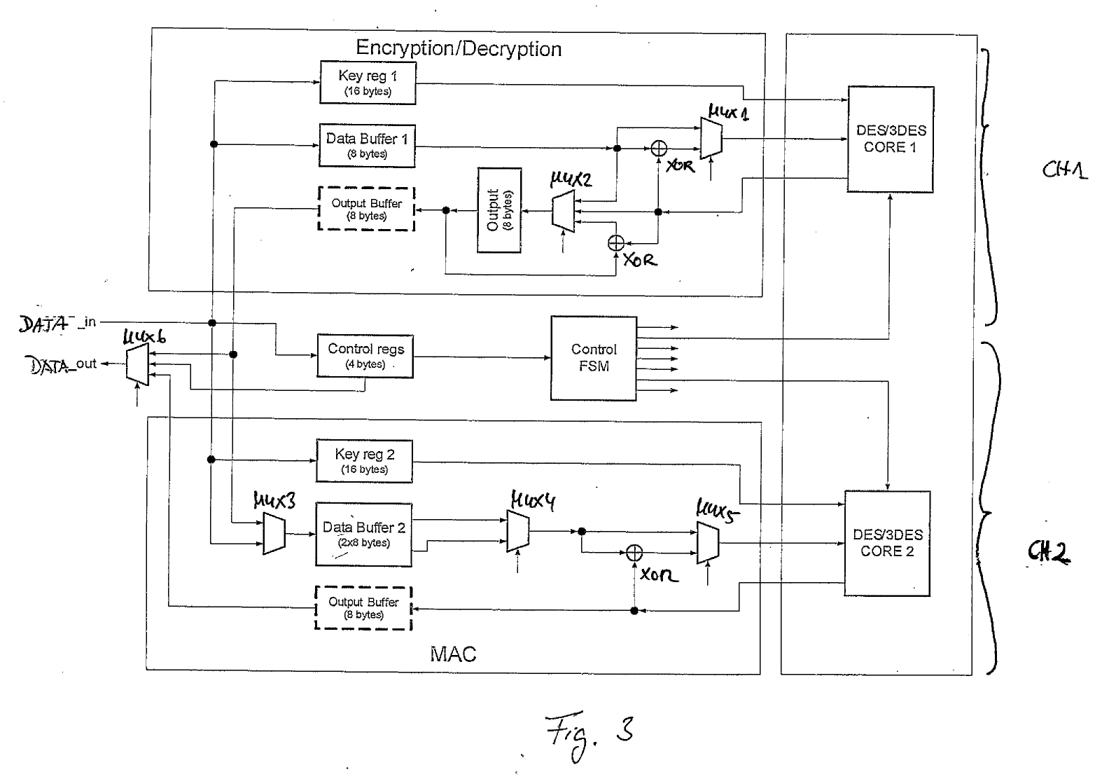

FIG. 3 shows a simplified block diagram of a preferred embodiment of the present invention. There are two processing stages (crypto cores) DES/(3)DES core 1 and the DES/(3)DES core 2. The first crypto core DES/(3)DES core 1 is coupled to an input data buffer 1, which is 8 bytes long, corresponding to 64 bit of a data block of a message to be encrypted or decrypted. A first key register Key Reg 1 is also coupled to the first core DES/(3)DES core 1 in order to provide the respective secret key for encryption or decryption. The output buffer in the first channel CH1 is only optional. Data can be directly fed to the second input data buffer 2 of the second channel CH2. The second channel CH2 is dedicated to perform the necessary encryption steps for computing the message authentication code. The second data buffer data buffer 2 has twice the size of the first data buffer in order to store consecutive encrypted or decrypted data blocks from the first channel or to store header information and a data block output from the first channel. The output buffer of the second channel is also just optional and can be omitted if data can be transferred immediately after computation. The control stage can be implemented as a finite state machine FSM. A control register Control Regs provides control information to the control stage FSM. The finite state machine FSM controls two separate DES encryption or decryption channels CH1 and CH2, which are both capable of performing single-DES as well as triple-DES operations. Both channels support the ECB mode for encryption and decryption. The first channel supports both encryption and decryption in CBC mode, the second channel CH2 supports CBC mode for encryption only. The two channels CH1 and CH can be configured to work together to enhance throughput while data is encrypted or decrypted according to the secure messaging format as defined by the ISO/IEC 7816-4 specification (DES Standard). In the preferred mode of using the preferred embodiment shown in FIG. 3, one channel is used to encrypt or decrypt the data while the other channel calculates the cryptographic signature of the data block's output from the first channel CH1 simultaneously. The first channel CH1 includes multiplexers MUX1, and MUX2 as well as XOR gates XOR, for performing the respective CBC or EBC operations. The same applies for the second channel CH2, where multiplexers MUX4 and MUX5 and XOR gates XOR provide the necessary operations for ECB or CBC mode. The multiplexer MUX3 selectively inputs the data block's output from the first channel CH1 or input data received through input DATA_IN. Multiplexer MUX6 is adapted to selectively output data from the first channel, the second channel or from the control registers to output DATA_OUT.

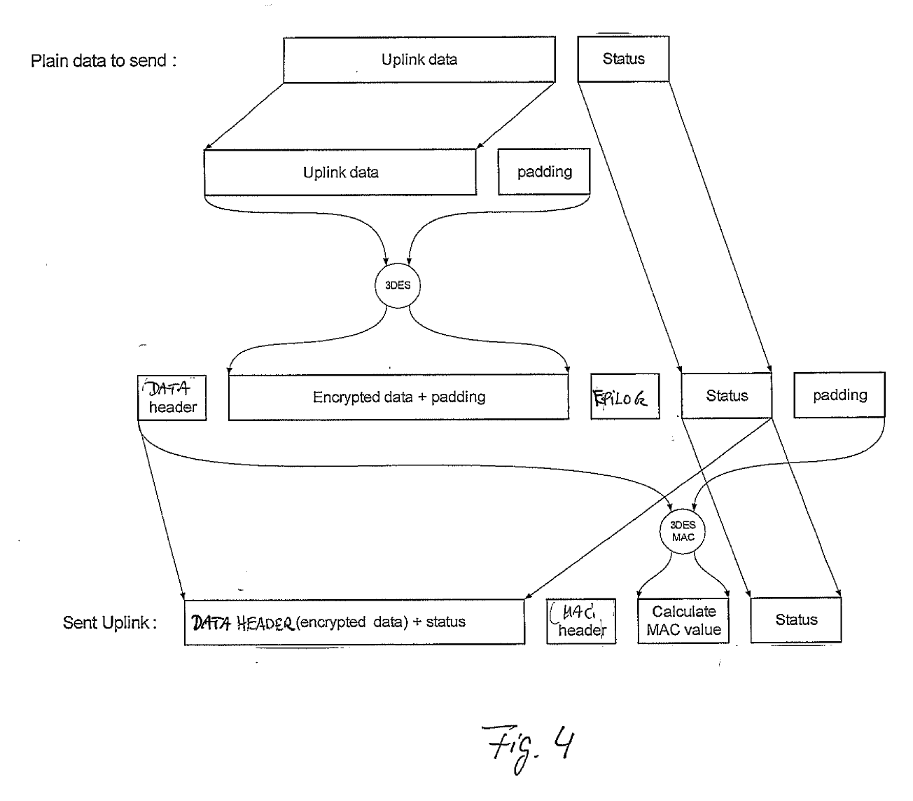

FIG. 4 shows a diagram illustrating data encryption according to a secure messaging protocol (e.g. the ISO/IEC 7816-4 Secure Messaging Protocol). This protocol defines that the data has to be encrypted and a cryptographical signature should be appended to it before it is sent over any unsecured path. The plain data to be sent is referred to as “uplink data”. Additional status information can be transmitted, which is not encrypted. If a block of the uplink data is smaller than 64 bit, additional bits are added to the uplink data in order to complete 64 bit. The uplink data and the optional padding data are encrypted in a crypto core according to a single-DES or triple-DES operation. The result is the encrypted data. Further, a data header information and an epilog information is appended to the encrypted data. The status information is passed through. The header, the epilog, the encrypted data and additional padding bits are encrypted in a second step in order to include the message authentication code, the result of which is the calculated MAC value. The data to be sent is then the data header, encrypted data plus status information, the MAC header, the calculated MAC value, and status information. According to the ISO/IEC 7816-4 Secure Messaging Protocol, the following data objects (DO) correspond to the previously defined data packets: DO'97: data header, DO'97: separator, DO'8E: MAC header, DO'99: epilog.

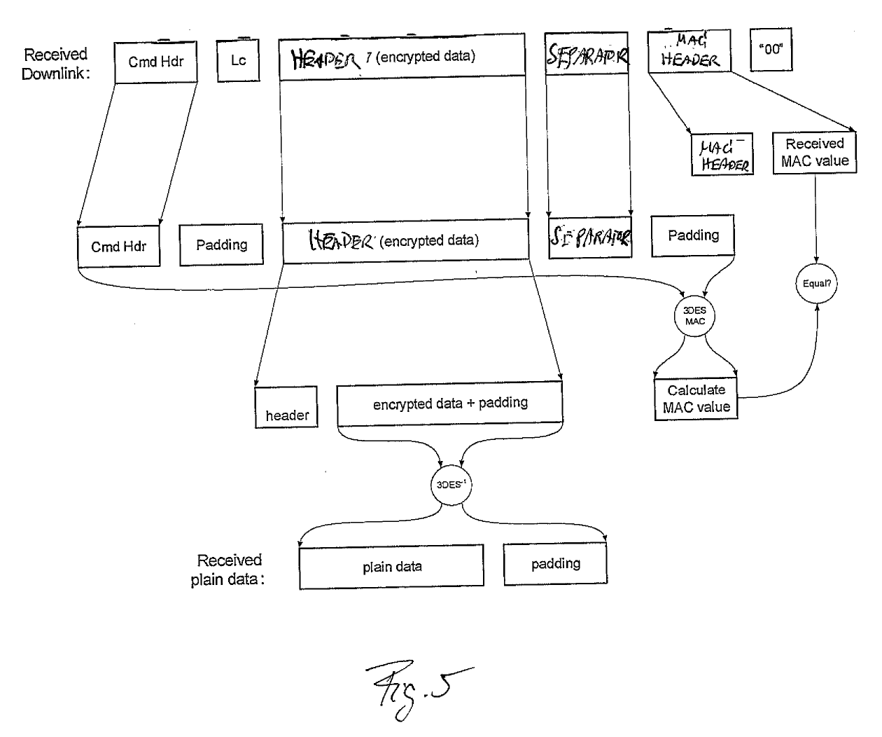

The decryption procedure is illustrated in FIG. 5. The received data includes a command header CmdHdr, a portion Lc, the encrypted data including data header, encrypted data, additional data header information as well as the MAC header, and optional zero bits. The command header CmdHdr, the padding bits, the data header and encrypted data, a separator and additional padding bits are passed to a crypto core for performing the triple-DES operation in order to retrieve the message authentication code MAC. The retrieved and calculated MAC value is compared to the received MAC value in order to check the authentication of the message. The data header information and the encrypted data including any optional padding bits is then decrypted in a triple-DES operation in order to receive the plain data and any pad ding bits. In terms of the ISO/IEC 7816-4 Secure Messaging Protocol, DO'87 is the separator, DO'87 is the data header, DO'E8 is the MAC header.

The double core DES3DES module according to the present invention is designed to enhance throughput when data is to be sent or to be received according to the secure messaging scheme. Since the message authentication code MAC is calculated over the encrypted data, which at some point is either written to the module for decryption or to read from it after encryption, the electronic device according to the present invention is preferably designed to automatically use this data as input into the MAC channel (CH2). This data must therefore not be moved separately into the second channel CH2 in order to calculate the MAC.

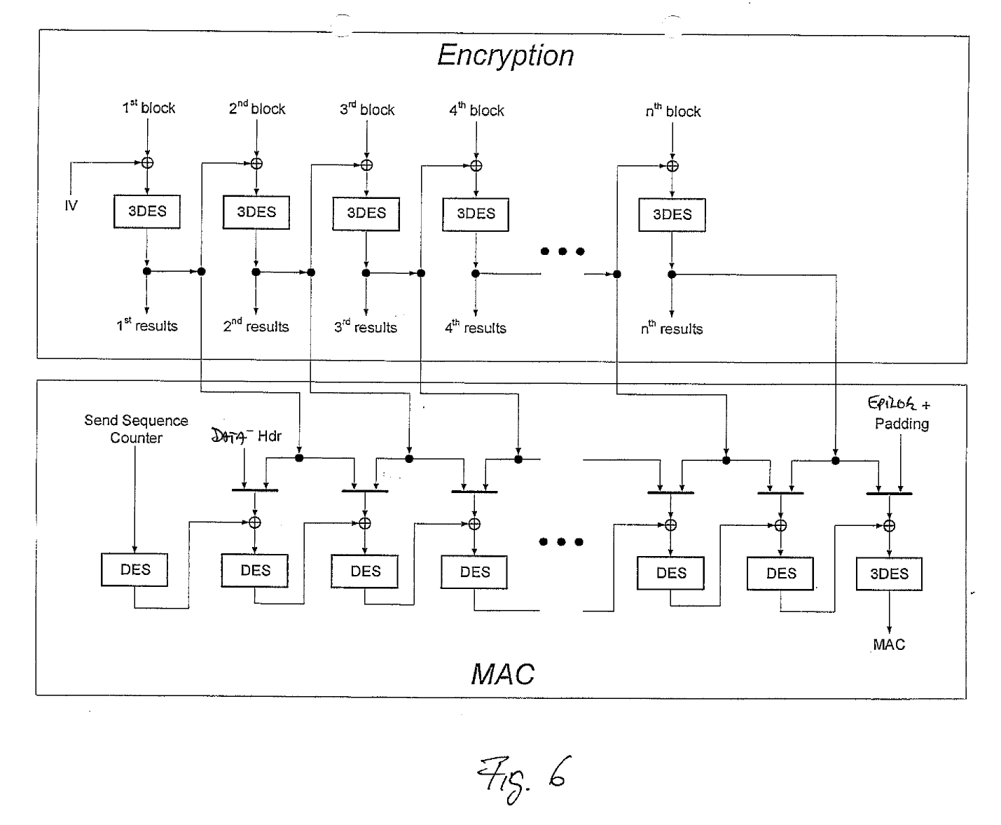

FIG. 6 shows a diagram illustrating a data flow according to the present invention. The MAC channel is set up to perform the necessary operations on the data that is read from the encryption channel (CH1 in FIG. 3) and to start synchronously to the encryption channel (CH1 in FIG. 3). Accordingly, the following operation and data flow can be observed after the electronic device according to the present invention has been set up:
1. Write Send Sequence Counter to MAC channel.
2. Write 1^{st} data block to encryption channel (DES core is started when the 8^{th} data byte is written to the encryption channel).
3. Write Data header (e.g. DO'87) into MAC channel.
4. Read 1^{st} encryption results (this data is automatically written to the MAC channel).
5. Write 2^{nd}, 3^{rd}, . . . , n^{th} data block into encryption channel and read the results after each operation.
6. After the last data block has been read, initiate one MAC operation manually.
7. At this point the MAC channel must be configured to do a triple DES encryption for the final operation.
8. Write epilog (e.g Data Object '99 header) and necessary padding into MAC channel and start the last MACing operation.
9. Read the cryptographic signature from the MAC channel.

The input data stream from the encryption block is split into a 7 byte data portion which is to be combined in the second DES path with the data header (1 byte, e.g. DO'87, according to the ISO/IEC 7816-4). Therefore, the last byte of the 8 byte output from the encryption block is passed to the next DES core and combined with the first 7 bytes of the respective output from the second block of the encryption stage. The epilog can be the DO'99 data object of the ISO/IEC 7816-4 Secure Messaging Protocol. This data splitting due to the necessary inclusion of the data header information is the reason for the double-size input buffer in the MAC stage shown in FIG. 3 (2 times 8 byte input data buffer Data Buffer 2 in CH2).

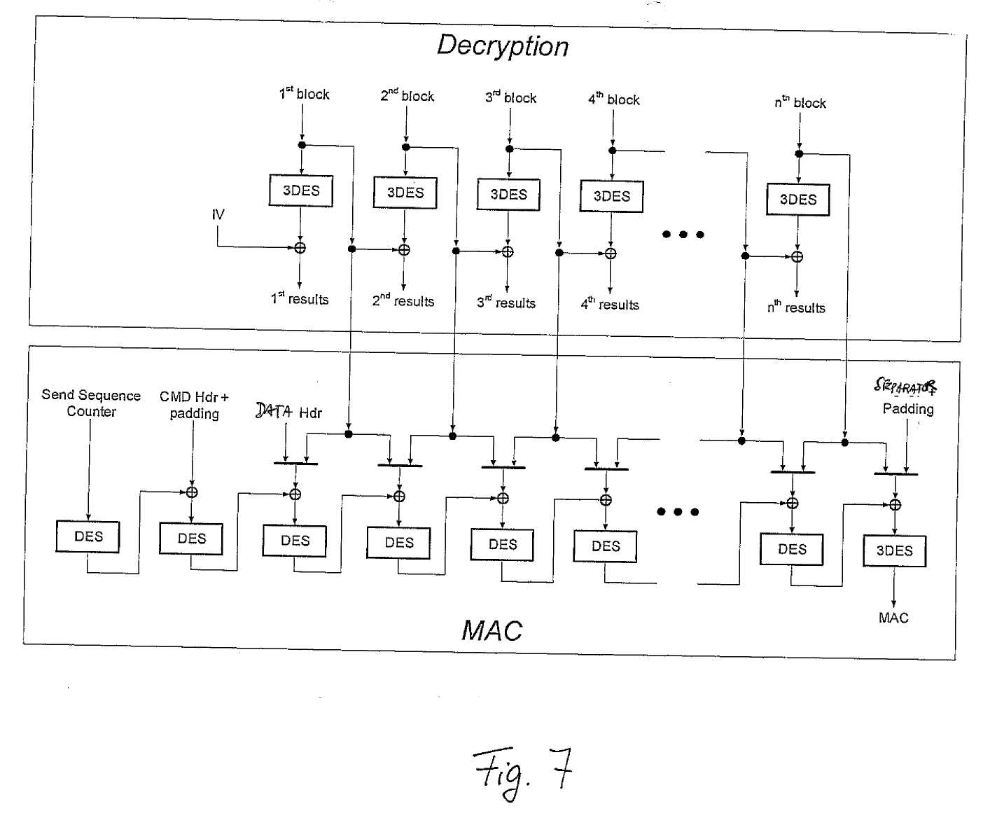

FIG. 7 illustrates a data flow for a decryption operation of the electronic device according to the present invention. Again vertically aligned DES blocks indicate that the two crypto cores work in parallel. For decryption, the second channel (MAC) has to perform two steps in advance for decrypting the send sequence counter and the command header CmdHdr plus padding information. A DES block in the MAC channel consecutively receives two blocks of encrypted data. As only a single DES operation is performed, the crypto core of the second channel can perform more operations in the time period the first crypto core needs for a decryption according to the triple-DES decryption.

The data and key registers in the module are preferably implemented as a kind of a left-shift register. The first byte or word that is written to these registers is written to the far left of the register. The following bytes or words are then always written to the right of the previous data. This allows the content of the registers to be viewed in lexical order (from left to right) which complies with many protocol specifications. The first byte of 8 bytes written into the data registers is therefore the leftmost byte of the 8 bytes. An example for a single DES operation looks as follows (all numbers are hexadecimal):

Key=0123 4567 89AB CDEF

Plain=CAFÉ ABBA 1234 ABCD

Cyphered=3E3B 1B17 F395 6E62

The first word of the key written to the key register is 0123 followed by 4567 and the last word CDEF. (The key must always be written word-wise into the key register.) The same applies to the data where the first byte is CA and the last byte CD. Then, the first result byte read is 3E and the last byte 62.

Only DES channel 1 (CH1) has a dedicated output register. The results from channel 2 (CH2 or MAC channel) are read directly from the registers in the DES core. It is therefore not possible to read any results from channel 2 while the DES core is running. This is only possible (or meaningful) for channel 1 when using ECB mode and when encrypting in CBC mode.

Again, the data stream from the decryption stage is split into two data paths. One receiving the first seven bits of the first block output from the decryption stage and the data header (1 byte), which can be the DO'87 of the ISO/IEC 7816-4 Secure Messaging Protocol. The separator added in the last 3DES stage of the MAC stage shown in FIG. 7 can be the DO'99 data packet of the ISOI/IEC 7816-4 Secure Messaging Protocol.

Although the present invention has been described with reference to a specific embodiment, it is not limited to this embodiment and no doubt alternatives will occur to the skilled person that lie within the scope of the invention as claimed.

1. An electronic device for encrypting and decrypting data blocks of a message having n data blocks in accordance with the data encryption standard (DES), the electronic device comprising:
a first data processing channel comprising a first processing stage for performing encryption or decryption of data blocks of a predefined length, and a first input data buffer coupled to a data input and to the first processing stage; and
a second data processing channel comprising a second processing stage for performing encryption or decryption of data blocks, a second data input buffer coupled to an output of the first processing stage; and to the second processing stage;
the electronic device further comprising a control stage (FSM) for controlling the first processing stage and the second processing stage, so as to perform an encryption or decryption step with the second processing stage on an encrypted/decrypted data block output from the first processing stage, wherein the control stage is adapted to control the first processing stage to perform data encryption or decryption according to the data encryption standard on each block and to control the second processing stage to compute a message authentication code over the encrypted/decrypted message received from the first processing stage block-by-block.

2. The electronic device according to claim 1, further comprising a first key register for storing a first encryption or decryption key to be used by the first processing stage, and a second key register for storing a second encryption or decryption key to be used by the second processing stage.

3. The electronic device according to claim 1, wherein the second input data buffer has twice the size of the first data buffer.

4. The electronic device according to claim 2, wherein the second input data buffer has twice the size of the first data buffer.

5. The electronic device according to claim 1, wherein the first processing stage and the second processing stage are both adapted to perform single-DES and triple-DES operations.

6. The electronic device according to claim 2, wherein the first processing stage and the second processing stage are both adapted to perform single-DES and triple-DES operations.

7. The electronic device according to claim 3, wherein the first processing stage and the second processing stage are both adapted to perform single-DES and triple-DES operations.

8. The electronic device according to claim 4, wherein the first processing stage and the second processing stage are both adapted to perform single-DES and triple-DES operations.

9. The electronic device according to claim 2, wherein the first and the second encryption and/or decryption key has a maximum length of 128 Bit.

10. The electronic device according to claim 3, wherein the first and the second encryption and/or decryption key has a maximum length of 128 Bit.

11. The electronic device according to claim 4, wherein the first and the second encryption and/or decryption key has a maximum length of 128 Bit.

12. The electronic device according to claim 1, wherein the first channel is adapted to perform ECB mode and CBC mode for encryption and decryption and the second channel is adapted to perform ECB for encryption and decryption and CBC mode for encryption only.

13. The electronic device according to claim 2, wherein the first channel is adapted to perform ECB mode and CBC mode for encryption and decryption and the second channel is adapted to perform ECB for encryption and decryption and CBC mode for encryption only.

14. The electronic device according to claim 3, wherein the first channel is adapted to perform ECB mode and CBC mode for encryption and decryption and the second channel is adapted to perform ECB for encryption and decryption and CBC mode for encryption only.

15. The electronic device according to claim 5, wherein the first channel is adapted to perform ECB mode and CBC mode for encryption and decryption and the second channel is adapted to perform ECB for encryption and decryption and CBC mode for encryption only.

16. The electronic device according to claim 6, wherein the first channel is adapted to perform ECB mode and CBC mode for encryption and decryption and the second channel is adapted to perform ECB for encryption and decryption and CBC mode for encryption only.

17. The electronic device according to claim 9, wherein the first channel is adapted to perform ECB mode and CBC mode for encryption and decryption and the second channel is adapted to perform ECB for encryption and decryption and CBC mode for encryption only.

18. The electronic device according to claim 1, wherein a data block has a length of 64 Bit.

19. A method for encrypting a message having n data blocks, the method comprising: encrypting a data block in a first processing stage in accordance with a single-DES or triple-DES operation, passing the encrypted data block to a second processing stage, and encrypting the encrypted data block in the second processing stage in accordance with a single-DES or triple-DES operation, wherein the first encrypting step performs data encryption on each block and the second encrypting step performs computation of a message authentication code over the encrypted message block-by-block.

20. A method for decrypting a message having n encrypted data blocks and a message authentication code, the method comprising: decrypting a data block in a first processing stage in accordance with a single-DES or triple-DES operation, passing the decrypted data block to a second processing stage, decrypting the decrypted data block in the second processing stage in accordance with a single-DES or triple-DES operation, wherein the first decrypting step performs data decryption on each block and the second decrypting step retrieves the message authentication code from n blocks.
